(19) United States
(12) Patent Application Publication
(10) Pub. No.: US 2022/0176472 A1
(43) Pub. Date: Jun. 9, 2022

(54) CUTTING TOOL WITH PCD INSERTS, SYSTEMS INCORPORATING SAME AND RELATED METHODS

(71) Applicant: US SYNTHETIC CORPORATION, Orem, UT (US)

(72) Inventors: Edwin Sean Cox, Spanish Fork, UT (US); Jeff Clark, Orem, UT (US); Jason Cardell, Orem, UT (US); Verl Dallin, Spanish Fork, UT (US); Jarrett Meier, Lehi, UT (US); Jason Lott, Payson, UT (US); Regan Leland Burton, Saratoga Springs, UT (US); Dan Bagley, Hidden Valley, PA (US)

(21) Appl. No.: 17/678,819

(22) Filed: Feb. 23, 2022

Related U.S. Application Data
(63) Continuation-in-part of application No. 16/529,176, filed on Aug. 1, 2019.
(60) Provisional application No. 62/713,862, filed on Aug. 2, 2018.

(51) Int. Cl. B23C 5/10

(52) U.S. Cl. CPC B23C 5/109; B23C 2226/315

(57) ABSTRACT

A cutting tool which may be used in machining various material may include a body and one or more cutting elements associated therewith. In one example, the cutting element(s) may comprise a superhard table, such as a polycrystalline diamond table. In some embodiments, the polycrystalline diamond table may have a diamond density of approximately 95 percent volume or greater. In some embodiments, the thickness of the superhard table may be approximately 0.15 inch. In some embodiments, the superhard table may include a chip-breaking feature or structure. Methods of shaping, finishing, or otherwise machining materials are also provided, including the machining of materials comprising titanium.

### BACKGROUND

This application is a continuation-in-part application of U.S. patent application Ser. No. 16/529,176 filed on Aug. 1, 2019, entitled CUTTING TOOL WITH PCD INSERTS, SYSTEMS INCORPORATING THE SAME AND RELATED METHODS, which claims the benefit of U.S. Provisional Patent Application No. 62/713,862, filed on Aug. 2, 2018, entitled CUTTING TOOL WITH PCD INSERTS, SYSTEMS INCORPORATING SAME AND RELATED METHODS, the disclosure of each of which is incorporated by reference herein, in its entirety, by this reference.

### BACKGROUND

Cutting tools are conventionally used in machining operations to remove material and form desired shapes and surfaces of a given object. For example, milling is a machining process wherein material is progressively removed in the form of “chips” to form a shape or surface from a given volume of material—often referred to as a workpiece. This may be accomplished by feeding the work piece into a rotating cutting tool (or vice-versa), often in a direction that is perpendicular to the axis of rotation of the cutting tool. Various types of cutters may be employed in milling operations, but most cutting tools include a body and one or more teeth (or cutting elements—which may be brazed or mechanically attached to the body) that cut into and remove material from the workpiece as the teeth of the rotating cutter engage the workpiece.

Nearly any solid material may be machined, including metals, plastics, composites and natural materials. Some materials are more easily machined than other types of materials, and the type of material being machined may dictate, to a large extent, the process that is undertaken to machine the workpiece, including the choice of cutting tool. For example, titanium and titanium alloys, while exhibiting a number of desirable mechanical and material characteristics, are notoriously difficult to machine.

While there are numerous reasons for the difficulty in milling titanium materials, some of them not entirely understood, some reasons may include its high strength, chemical reactivity with cutter materials, and low thermal conductivity. These characteristics tend to reduce the life of the cutter. Additionally, the relatively low Young's modulus of titanium materials is believed to lead to “chatter” in the cutting tool, often resulting in a poor surface finish of a machined workpiece. Further, the “chips” that are typically formed in machining processes such as milling are not typically small broken chips but, rather, long continuous chips which can become tangled in the machinery, posing a safety hazard and making it difficult to conduct automatic machining of titanium materials.

While there have been various attempts to provide cutting tools that provide desirable characteristics for machining various materials, including normally difficult-to-machine materials such as titanium, there is a continued desire in the industry to provide improved cutting tools for machining of a variety of materials and for use in a variety of cutting processes.

### SUMMARY

Embodiments of the invention relate to superhard elements, such as superhard element that may be used in the machining of various materials. In an embodiment, a superhard element is disclosed. The superhard element includes a top surface, a bottom surface opposite the top surface, at least one lateral surface extending between the top surface and the bottom surface, and a surface distinct from the top surface that is angled or curved relative to the top surface.

In an embodiment, a cutting tool is disclosed. The cutting tool includes a cutting tool body and at least one cutting element attached to the cutting tool body. The at least one cutting element includes a top surface, a bottom surface opposite the top surface, at least one lateral surface extending between the top surface and the bottom surface, and a surface distinct from the top surface that is angled or curved relative to the top surface. In an embodiment, a method of forming a superhard element is disclosed. The method includes providing a superhard element. The superhard element includes a top surface, a bottom surface opposite the top surface, and at least one lateral surface extend between the top surface and the bottom surface. The method also includes forming a surface distinct from the top surface that is angled or curved relative to the top surface. In an embodiment, a method of removing material from a workpiece is disclosed. The method includes providing a cutting tool. The cutting tool includes a cutting tool body and at least one cutting element attached to the cutting tool body. The at least one cutting element includes a top surface, a bottom surface opposite the top surface, and at least one lateral surface extending between the top surface and the bottom surface. The at least one cutting element also includes a surface distinct from the top surface that is angled or curved relative to the top surface. The method also includes rotating at least one of the cutting tool or the workpiece about an axis and engaging the workpiece with the cutting tool. In an embodiment, a superhard element is disclosed. The superhard element includes a top surface, a bottom surface opposite the top surface, at least one lateral surface extending at least partially between the top surface and the bottom surface, and an edge extending between the top surface and the at least one lateral surface. No feature of the superhard element extends further from the bottom surface than the top surface.

Various elements, components, features or acts of one or more embodiments described herein may be combined with elements, components, features, or acts of other embodiments without limitation.

### BRIEF DESCRIPTION OF THE DRAWINGS

The drawings illustrate various embodiments of the invention, wherein common reference numerals refer to similar, but not necessarily identical, elements or features in different views or embodiments shown in the drawings.

FIG. 1 is a schematic drawing showing a milling operation according to one embodiment of the present disclosure;

FIG. 2 is a schematic drawing showing a milling operation according to another embodiment of the present disclosure;

FIGS. 3 and 4 are perspective and side views of a cutting tool in accordance with an embodiment of the present disclosure;

FIGS. 5 and 6 are top and side views of a cutting insert according to an embodiment of the present disclosure;

FIG. 7 is a cross-sectional view taken along lines 7-7 as indicated in FIG. 6;

FIGS. 8A and 8B are enlarged views of a portion of the insert shown in FIG. 7 according to embodiments of the present disclosure;

FIG. 9 is a side view of a cutting insert according to an embodiment of the present disclosure;

FIG. 10 is a cross-sectional view taken along lines 10-10 as indicated in FIG. 9;

FIGS. 11A-11C are enlarged views of a portion of the insert shown in FIG. 10 according to embodiments of the present disclosure;

FIG. 12 is a cross-section view, similar to the view shown in FIG. 10, according to another embodiment of the present disclosure.

FIGS. 13-15 are enlarged, cross-sectional views of a portion of superhard elements having different edges, according to different embodiments.

FIGS. 16 and 17 are enlarged cross-sectional views of different cutting elements, according to different embodiments.

### DETAILED DESCRIPTION

Embodiments of the disclosure relate to superhard elements, such as superhard elements used in cutting tools. Such cutting tools used in machining processes, including milling, drilling, turning as well as variations and combinations thereof. The cutting tools may be used in shaping, forming and finishing a variety of different materials, including materials that are often difficult to machine, including, for example, titanium, titanium alloys and nickel based materials.

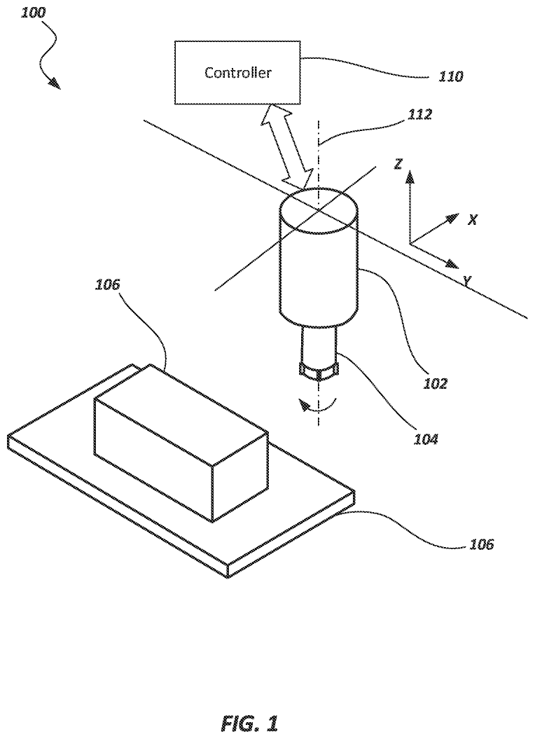

Referring to FIG. 1, an example of the operation of a vertical milling machine (VMM) 100 is schematically shown. The VMM 100 includes a spindle 102 having a cutting tool 104 removably coupled therewith in accordance with an embodiment of the present disclosure. The VMM 100 also includes a table 106 on which a workpiece 108 is placed. A CNC (computer numerically controlled) controller 110 is in communication with the spindle 102 and may control the action of the spindle 102. While not expressly shown in FIG. 1, a frame may couple several of the components together (e.g., the spindle 102 and the table 106). The spindle 102 is configured to rotate the cutting tool 104 about an axis 112 and to also move the cutting tool 104 in the X, Y and Z directions relative to the table 106 and associated workpiece 108.

As noted above, the controller 110 is in communication with the spindle 102 and configured to control various operations of the VMM 100. For example, the controller 110 may be configured to control the rotational speed of the cutting tool 104 and also move the spindle 102 (and, thus, the cutting tool 104) in specified directions along the X-Y-Z axes at a desired “feed rate” relative to the workpiece 108. Thus, the controller 110 may enable the cutting tool 104 to remove material from the workpiece 108 so as to shape it and provide a desired surface finish to the workpiece 108 as will be appreciated by those of ordinary skill in the art.

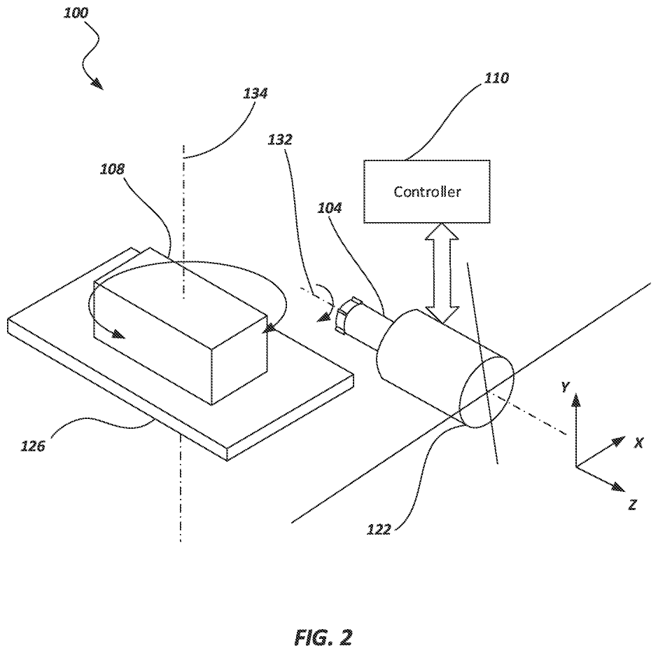

Referring to FIG. 2, an example of the operation of a horizontal milling machine (HMM) 120 is schematically shown. The HMM 120 includes a spindle 122 having a cutting tool 104 removably coupled therewith in accordance with an embodiment of the present disclosure. The HMM 120 also includes a table 126 on which a workpiece 108 is placed. The table 126 may be vertically oriented. A CNC controller 110 is in communication with the spindle 122 and controls the action of the spindle 122. In one embodiment, the controller 110 may also be in communication with the table 126 and/or spindle 122 to displace one or both in a desired direction, respectively, as discussed below. While not expressly shown in FIG. 2, a frame may couple several of the components together (e.g., the spindle 122 and the table 126). The spindle 122 is configured to rotate the cutting tool 104 about an axis 132 and to also move the cutting tool 104 in the X, Y and Z directions relative to the table 126 and the associated workpiece 108. Additionally, the table 126 may be configured to rotate about a B-axis 134, which is substantially orthogonal to the rotational axis 132. In one embodiment, the controller 110 may be configured to control the rotational speed of the cutting tool 104, displace the spindle 122 (and, thus, the cutting tool 104) in a specified direction and at a desired “feed rate” relative to the workpiece 108, and also rotate the table 126 (and thus the workpiece 108). Thus, the controller 110 may enable the cutting tool 104 to remove material from the workpiece 108 so as to shape it and provide a desired surface finish to the workpiece 108 as will be appreciated by those of ordinary skill in the art.

It is noted that the milling machines 100 and 120 described with respect to FIGS. 1 and 2 are merely examples, and that a variety of other machining systems are contemplated as incorporating a cutting tool such as is described in further detail below for use in a variety of machining operations.

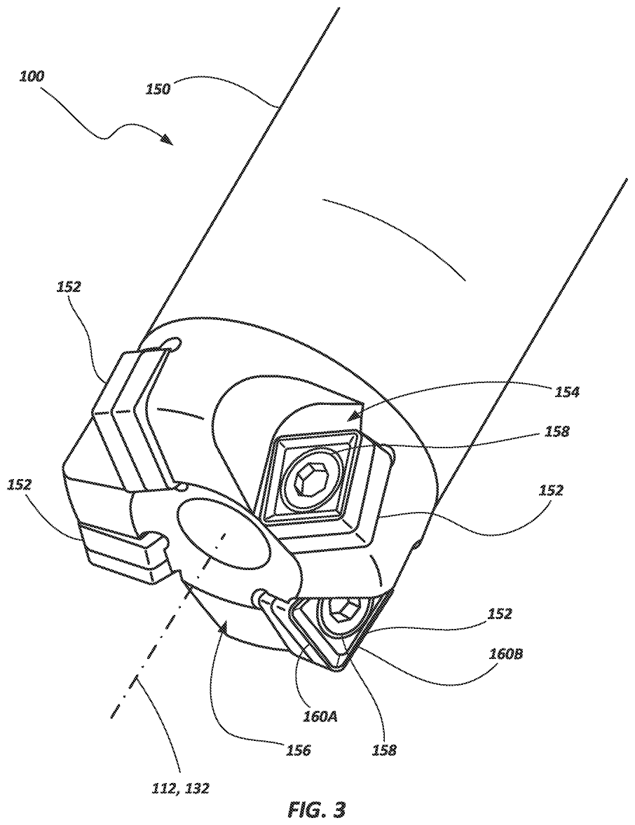

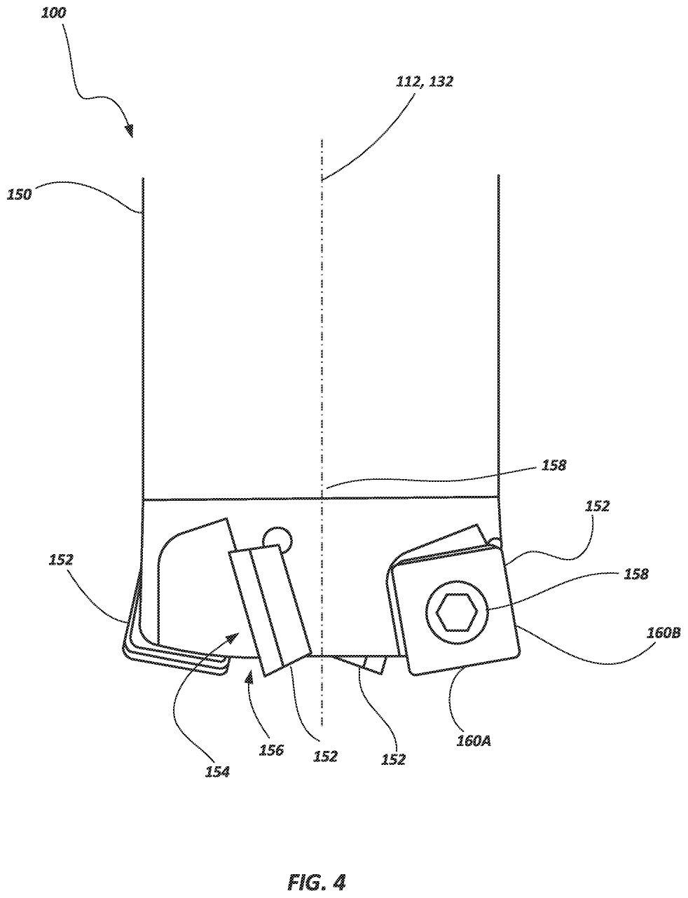

Referring now to FIGS. 3 and 4, a cutting tool 104 is shown having a tool body 150 and a plurality of superhard elements 152. The superhard elements 152 are examples of cutting elements or inserts. The superhard elements 152 may be disposed in pockets 154 formed in an end or region of the body 156. In some embodiments, the cutting elements may be removably coupled with the tool body 150 such as by a fastener 158. In some embodiments, the superhard elements 152 may be indexable relative to the tool body 150. Thus, for example, as one face or edge 160A of a given cutting element 152 becomes worn or damaged, the cutting element 152 may be rotated relative to the tool body 150 such that a new face or edge 160B may be presented to a workpiece for the cutting and removal of material therefrom. In some embodiments, the superhard elements 152 may be removably coupled with the body 150 using clamping mechanisms. In some embodiments, the superhard elements 152 may be coupled with the body 150 by brazing or other material joining techniques.

Various materials may be used in forming the body 150 of the cutting tool including various metals and metal alloys. In some embodiments, the body 150 may comprise an aluminum or aluminum alloy material. Other materials that may be used in forming the tool body include, without limitation, steel and steel alloys (e.g. stainless steels), nickel and nickel alloys, titanium and titanium alloys, tungsten and tungsten alloys, tungsten carbide and associated alloys, other metals, one or more ceramics, one or more composites, or combinations thereof.

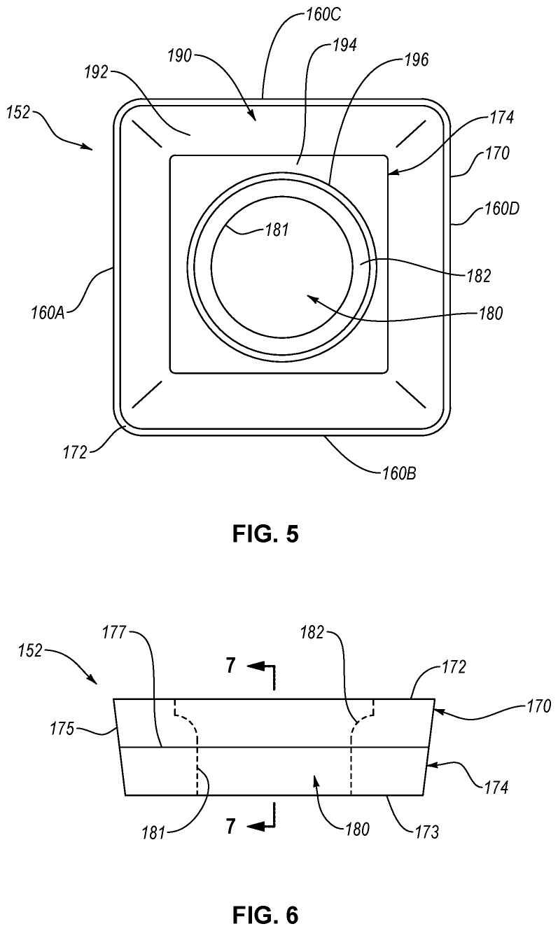

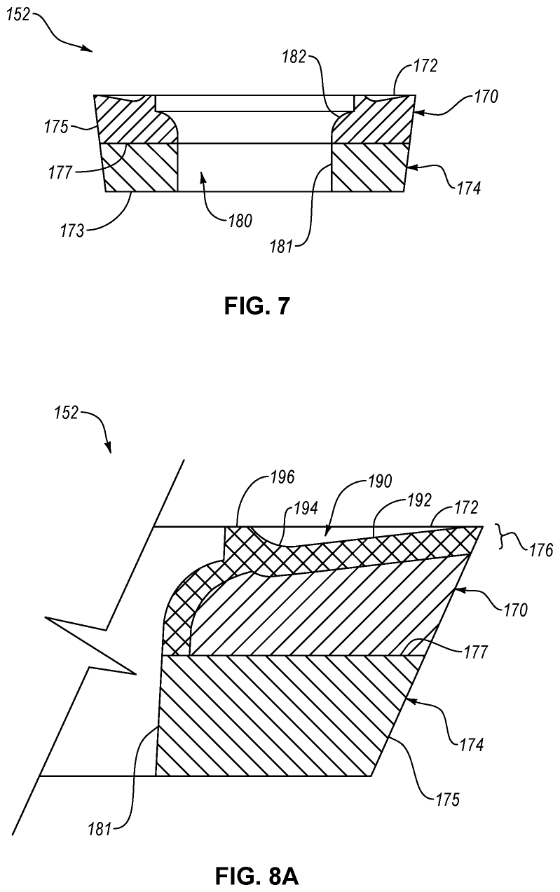

In some embodiments, the superhard elements 152 may comprise superhard, superabrasive materials. For example, the superhard elements 152 may include polycrystalline cubic boron nitride, polycrystalline diamond or other superabrasive materials. For example, referring to FIGS. 5-7 the superhard elements 152 may include a superhard, superabrasive table 170 defining a top surface 172 (e.g., a rake surface), a bottom surface 173 opposite the top surface 172, and at least one outer lateral surface 175 extending between the top surface 172 and the bottom surface 173 (e.g., from or near the top surface 172 to or near the bottom surface 173). In some embodiments, the cutting element 152 may comprise a polycrystalline diamond compact (“PDC”) including a polycrystalline diamond (“PCD”) table to which a substrate 174 is attached (e.g., bonded). In some embodiments, the interface 177 between the table 170 and the substrate 174 may be substantially flat or planar. In other embodiments, the interface 177 may be domed or curved. In other embodiments, the interface 177 between the table 170 and the substrate 174 may include a plurality of raised features or recessed features (e.g., dimples, grooves, ridges, etc.).

In some embodiments, the substrate 174 may comprise a cobalt-cemented tungsten carbide substrate bonded to the table 170. In one particular example, the table 170 may include a relatively “thick diamond” table which exhibits a thickness (i.e., from the top surface 172 to the interface 177 between the table 170 and the substrate 174) that is approximately 0.04 inch or greater. In other embodiments, the table 170 exhibits a thickness of approximately 0.04 or greater, approximately 0.05 inch or greater, 0.07 inch or greater, 0.09 inch or greater, 0.11 inch or greater, 0.12 inch or greater, 0.15 inch or greater, 0.2 inch or greater or 0.3 inch or greater.

In one embodiment, the table 170 exhibits a thickness between approximately 1 mm and approximately 1.8 mm. In one embodiment, the table 170 exhibits a thickness between approximately 1.25 mm and approximately 1.8 mm. In one embodiment, the table 170 exhibits a thickness between approximately 1.8 mm and approximately 2.3 mm. In one embodiment, the table 170 exhibits a thickness between approximately 2.3 mm and approximately 2.8 mm. In one embodiment, the table 170 exhibits a thickness between approximately 2.8 mm and approximately 3.1 mm inch. In one embodiment, the table 170 exhibits a thickness between approximately 3.1 mm inch and approximately 3.8 mm. In one embodiment, the table 170 exhibits a thickness between approximately 3.8 mm and approximately 5.1 mm. In one embodiment, the table 170 exhibits a thickness between approximately 5.1 mm and approximately 7.6 mm. Examples of forming relatively thick PDCs for use in bearings and in use of subterranean drilling may be found in U.S. Pat. No. 9,080,385, the disclosure of which is incorporated by reference herein in its entirety.

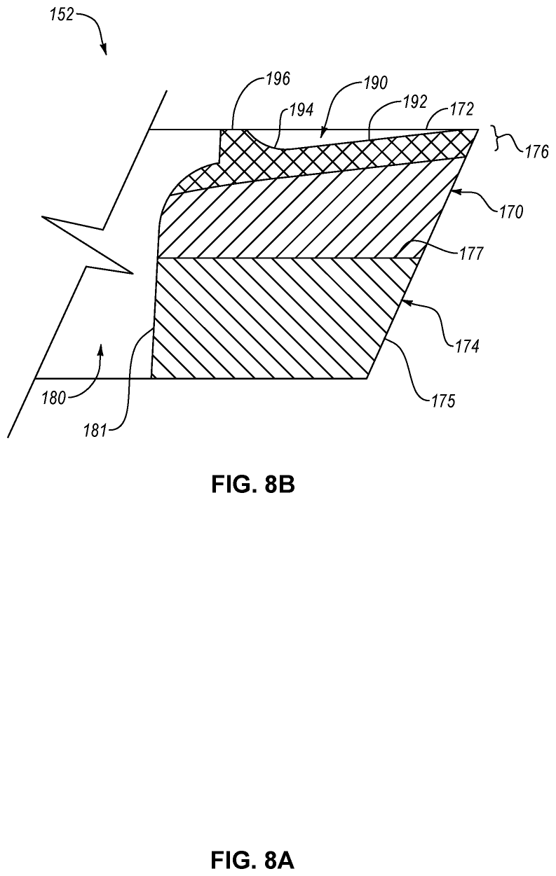

The PCD table 170 includes a plurality of directly bonded-together diamond grains exhibiting diamond-to-diamond bonding therebetween (e.g., sp3 bonding), which define a plurality of interstitial regions. A portion of, or substantially all of, the interstitial regions of the PCD table may include a metal-solvent catalyst or a metallic infiltrant disposed therein that is infiltrated from the substrate 174 or from another source during fabrication. For example, the metal-solvent catalyst or metallic infiltrant may be selected from iron, nickel, cobalt, and alloys of the foregoing. In some embodiments, the PCD table 170 may further include thermally-stable diamond in which the metal-solvent catalyst or metallic infiltrant has been partially or substantially completely depleted (e.g., region 176 shown in FIGS. 8A and 8B) from a selected surface or volume of the PCD table, such as via an acid leaching process. Thermally-stable PCD may also be sintered with one or more alkali metal catalysts. In some embodiments, the catalyst-depleted region 176 may exhibit a depth that is substantially conformal with an outer surface of the PCD table 170, such as shown in FIGS. 8A and 8B. In other embodiments, the catalyst-depleted region 176 may generally extend a desired depth from at least a plane extending through the uppermost portions of the table 170 (e.g., through the peripheral edges of the top surface 172 and/or through the upper surface of the lip 196—see FIG. 8A). Thus, removal of the catalyst or infiltrant may be done prior to or after the forming of the structures and features (e.g., chip breakers 190, opening 180, etc. as described hereinbelow). For example, FIG. 8B shows an embodiment where the removal of catalyst material does not extend substantially into the opening 180. This may be because of selective catalyst removal techniques (e.g., masking), or it may be because the opening 180 was formed after catalyst removal.

In some embodiments, PDCs which may be used as the superhard elements 152 may be formed in an HPHT process. For example, diamond particles may be disposed adjacent to the substrate 174, and subjected to an HPHT process to sinter the diamond particles to form the PCD table and bond the PCD table to the substrate 174, thereby forming the PDC. The temperature of the HPHT process may be at least about 1000° C. (e.g., about 1200° C. to about 1600° C.) and the cell pressure, or the pressure in the pressure-transmitting medium (e.g., a refractory metal can, graphite structure, pyrophyllite, etc.), of the HPHT process may be at least 4.0 GPa (e.g., about 5.0 GPa to about 12 GPa or about 7.5 GPa to about 11 GPa) for a time sufficient to sinter the diamond particles.

In some embodiments, the diamond particles may exhibit an average particle size of about 50 μm or less, such as about 30 μm or less, about 20 μm or less, about 10 μm to about 20 μm, about 10 μm to about 18 μm, about 12 μm to about 18 μm, or about 15 μm to about 18 μm. In some embodiments, the average particle size of the diamond particles may be about 10 μm or less, such as about 2 μm to about 5 μm or submicron. In some embodiments, the diamond particles may exhibit multiple sizes and may comprise, for example, a relatively larger size and at least one relatively smaller size. As used herein, the phrases “relatively larger” and “relatively smaller” refer to particle sizes (by any suitable method) that differ by at least a factor of two (e.g., 30 μm and 15 μm). According to various embodiments, the mass of diamond particles may include a portion exhibiting a relatively larger size (e.g., 30 μm, 20 μm, 15 μm, 12 μm, 10 μm, 8 μm) and another portion exhibiting at least one relatively smaller size (e.g., 6 μm, 5 μm, 4 μm, 3 μm, 2 μm, 1 μm, 0.9 μm, 0.8 μm, 0.7 μm, 0.6 μm, 0.5 μm, less than 0.5 μm, 0.4 μm, 0.3 μm, 0.2 μm, 0.1 μm, less than 0.1 μm). For example, in one embodiment, the diamond particles may include a portion exhibiting a relatively larger size between about 10 μm and about 40 μm and another portion exhibiting a relatively smaller size between about 0.5 μm and 4 μm. In some embodiments, the diamond particles may comprise three or more different sizes (e.g., one relatively larger size and two or more relatively smaller sizes), without limitation. The PCD table so-formed after sintering may exhibit an average diamond grain size that is the same or similar to any of the foregoing diamond particle sizes and distributions. More details about diamond particle sizes and diamond particle size distributions that may be employed are disclosed in U.S. Pat. No. 9,346,149, the disclosure of which is incorporated by reference herein in its entirety.

In some embodiments, the diamond grains of the resulting table 170 may exhibit an average grain size that is equal to or less than approximately 12 μm and include cobalt content of greater than about 7 weight percent (wt. %) cobalt. In some other embodiments, the diamond grains of the resulting table 170 may exhibit an average grain size that is equal to or greater than approximately 20 μm and include cobalt content of less than approximately 7 wt. %. In some embodiments, the diamond grains of the resulting table may exhibit an average grains size that is approximately 10 μm to approximately 20 μm.

In some embodiments, tables 170 may be formed as PCD tables at a pressure of at least about 7.5 GPa, may exhibit a coercivity of 115 Oe or more, a high-degree of diamond-to-diamond bonding, a specific magnetic saturation of about 20 G·cm³/g or less (e.g., about 15 G·cm³/g or less), and a metal-solvent catalyst content of about 7.5 wt. % or less. The PCD may include a plurality of diamond grains directly bonded together via diamond-to-diamond bonding to define a plurality of interstitial regions. At least a portion of the interstitial regions or, in some embodiments, substantially all of the interstitial regions may be occupied by a metal-solvent catalyst, such as iron, nickel, cobalt, or alloys of any of the foregoing metals. For example, the metal-solvent catalyst may be a cobalt-based material including at least 50 wt. % cobalt, such as a cobalt alloy.

The metal-solvent catalyst that occupies the interstitial regions may be present in the PCD in an amount of about 7.5 wt. % or less. In some embodiments, the metal-solvent catalyst may be present in the PCD in an amount of about 3 wt. % to about 7.5 wt. %, such as about 3 wt. % to about 6 wt. %. In other embodiments, the metal-solvent catalyst content may be present in the PCD in an amount less than about 3 wt. %, such as about 1 wt. % to about 3 wt. % or a residual amount to about 1 wt. %. By maintaining the metal-solvent catalyst content below about 7.5 wt. %, the PCD may exhibit a desirable level of thermal stability.

Generally, as the sintering pressure that is used to form the PCD increases, the coercivity may increase and the magnetic saturation may decrease. The PCD defined collectively by the bonded diamond grains and the metal-solvent catalyst may exhibit a coercivity of about 115 Oe or more and a metal-solvent catalyst content of less than about 7.5 wt. % as indicated by a specific magnetic saturation of about 20 G·cm³/g or less (e.g., about 15 G·cm³/g or less). In a more detailed embodiment, the coercivity of the PCD may be about 115 Oe to about 250 Oe and the specific magnetic saturation of the PCD may be greater than 0 G·cm³/g to about 20 G·cm³/g (e.g., greater than 0 G·cm³/g to about 20 G·cm³/g). In an even more detailed embodiment, the coercivity of the PCD may be about 115 Oe to about 175 Oe and the specific magnetic saturation of the PCD may be about 5 G·cm³/g to about 20 G·cm³/g (e.g., about 5 G·cm³/g to about 20 G·cm³/g). In yet an even more detailed embodiment, the coercivity of the PCD may be about 155 Oe to about 175 Oe and the specific magnetic saturation of the PCD may be about 10 G·cm³/g to about 20 G·cm³/g (e.g., about 10 G·cm³/g to about 20 G·cm³/g). The specific permeability (i.e., the ratio of specific magnetic saturation to coercivity) of the PCD may be about 0.10 or less, such as about 0.060 to about 0.090. Despite the average grain size of the bonded diamond grains being less than about 30 μm, the metal-solvent catalyst content in the PCD may be less than about 7.5 wt. % resulting in a desirable thermal stability.

In one embodiment, diamond particles having an average particle size of about 18 μm to about 20 μm are positioned adjacent to a cobalt-cemented tungsten carbide substrate and subjected to an HPHT process at a temperature of about 1390° C. to about 1430° C. and a cell pressure of about 7.8 GPa to about 8.5 GPa. The PCD so-formed as a PCD table bonded to the substrate may exhibit a coercivity of about 155 Oe to about 175 Oe, a specific magnetic saturation of about 10 G·cm³/g to about 20 G·cm³/g (e.g., about 15 G·cm³/g to about 20 G·cm³/g), and a cobalt content of about 5 wt. % to about 7.5 wt. %.

In one or more embodiments, a specific magnetic saturation constant for the metal-solvent catalyst in the PCD may be about 185 G·cm³/g to about 215 G·cm³/g. For example, the specific magnetic saturation constant for the metal-solvent catalyst in the PCD may be about 195 G·cm³/g to about 205 G·cm³/g. It is noted that the specific magnetic saturation constant for the metal-solvent catalyst in the PCD may be composition dependent.

Generally, as the sintering pressure is increased above 7.5 GPa, a wear resistance of the PCD so-formed may increase. For example, the Gᵣₐₜᵢₒ may be at least about 4.0×10⁶, such as about 5.0×10⁶ to about 15.0×10⁶ or, more particularly, about 8.0×10⁶ to about 15.0×10⁶. In some embodiments, the Gᵣₐₜᵢₒ may be at least about 30.0×10⁶. The Gᵣₐₜᵢₒ is the ratio of the volume of workpiece cut (e.g., between about 470 in³ of barre granite to about 940 in³ of barre granite) to the volume of PCD worn away during the cutting process. It is noted that while such a process may involve a so-called “granite log test,” this process is still applicable for determining the Gᵣₐₜᵢₒ of the PCD even though the cutter may be intended for use in metal cutting processes rather than rock cutting or drilling.

The material characteristics discussed herein, as well as other characteristics that may be provided in a cutting element 152, including processes for measuring and determining such characteristics, as well as methods of making such cutting elements, are described in U.S. Pat. Nos. 7,866,418, 8,297,382, and 9,315,881, the disclosure of each of which is incorporated by reference herein in its entirety.

In some embodiments, the table 170 may comprise high density polycrystalline diamond. For example, in some embodiments, the table 170 may comprise approximately 95 percent diamond by volume (vol. %) or greater. In some embodiments, the table 170 may comprise approximately 98 vol. % diamond or greater. In some embodiments, the table 170 may comprise approximately 99 vol. % diamond or greater. In other embodiments, the table 170 may comprise polycrystalline diamond exhibiting a relatively low diamond content(e.g., less than 95 vol. % diamond).

In some embodiments, the table 170 may be integrally formed with the substrate 174 such as discussed above. In some other embodiments, the table 170 may be a pre-formed table that has been HPHT bonded to the substrate 174 in a second HPHT process after being initially formed in a first HPHT process. For example, the table 170 may be a pre-formed PCD table that has been leached to substantially completely remove the metal-solvent catalyst used in the manufacture thereof and subsequently HPHT bonded or brazed to the substrate 174 in a separate process.

The substrate 174 may comprise any number of different materials, and may be integrally formed with, or otherwise bonded or connected to, the table 170. Materials suitable for the substrate 174 may include, without limitation, cemented carbides, such as tungsten carbide, titanium carbide, chromium carbide, niobium carbide, tantalum carbide, vanadium carbide, or combinations thereof cemented with iron, nickel, cobalt, or alloys thereof.

However, in some embodiments, the substrate 174 may be omitted and the superhard elements 152 may include a superhard, superabrasive material, such as a polycrystalline diamond body that has been leached to deplete the metal-solvent catalyst therefrom or that may be an un-leached PCD body.

As discussed above, in some embodiments, the table 170 may be leached to deplete a metal-solvent catalyst or a metallic infiltrant therefrom in order to enhance the thermal stability of the table 170. For example, when the table 170 is a PCD table, the table 170 may be leached to remove at least a portion of the metal-solvent catalyst that was used to initially sinter the diamond grains to form a leached thermally-stable region 176, from a working region thereof to a selected depth. The leached thermally-stable region may extend inwardly from the top surface 172 to a selected depth. In an embodiment, the depth of the thermally-stable region may be about 50 μm to about 1,500 μm. More specifically, in some embodiments, the selected depth is about 50 μm to about 900 μm, about 200 μm to about 600 μm, or about 600 μm to about 1200 μm. The leaching may be performed in a suitable acid, such as aqua regia, nitric acid, hydrofluoric acid, or mixtures of the foregoing.

As depicted in FIGS. 3-7, the superhard elements 152 may be configured to exhibit a substantially square outer profile when viewed from above (i.e., as seen specifically in FIG. 5). Such a geometry provides multiple cutting faces or edges 160A-160D which may be indexed relative to a cutting tool body 150 for extended service of the superhard elements 152. However, it is noted that other shapes and outer profiles are contemplated including, for example, circular, curved, triangular, hexagonal, octagonal, and other regular or irregular polygons.

As seen in FIGS. 5 and 6, the superhard elements 152 may also include an opening 180 formed in the table 170 and substrate 174 to accommodate a fastener for coupling of the cutting element 152 with a cutting tool body 150. The opening 180 may be spaced from the outer lateral surface 175. The opening 180 may be defined by at least one inner lateral surface 181 (e.g., surfaces defining the countersink region 182, the declining ramped surface portion 192, etc.) extending between the top surface 172 and the bottom surface 173. The opening 180 may include a countersunk region 182 (or a counter bore, depending on the type of fastener being used) to enable a fastener to be positioned flush with or below the top surface 172 of the table 170 when the cutting element 152 is coupled with a cutting tool body 150.

It is noted that other features may be provided in the superhard elements 152 including, for example, features for breaking chips of material that are being removed from the workpiece when engaged by the rotating cutting tool 104. For example, as seen best in FIGS. 5 and 8, the cutting elements may include formations or structures referred to as chip breakers 190. The chip breakers 190 may include a declining ramped surface portion 192 formed within the table 170 extending radially inward from a location adjacent the outer periphery of the table 170. For example, the declining ramped surface portion 192 may extend inwardly an inner location of the top surface 172. The chip breakers 190 may further include a portion that is angled or curved, referred to as a return portion 194, that leads up to a protruding lip 196 positioned adjacent to and surrounding the opening 180. As material is removed from a workpiece, the removed material travels along the ramped surface portion 192 and then abruptly changes directions as it encounters the return portion 194, promoting the removed material to form tight ribbons and/or promoting the breaking of the removed material into smaller “chips.” Forming the material into tight ribbons and/or breaking the material removed from a workpiece into smaller, discrete chips, instead of allowing the removed material to remain as long and loose ribbons strings helps to reduce potential interference of the removed material with the ongoing machining process.

In an embodiment, the cutting element 152 does not include any features (e.g., any portion of the chip breakers 190, such as the lip 196) that extend further from the bottom surface 173 than the top surface 172. In other words, the features of the cutting element 152 are relief-cut features and no features of the cutting element 152 extend beyond the plane extending through the top surface 172. Forming the features of the cutting element 152 as relief-cut features may facilitate the manufacture of the cutting element 152 since, in some embodiments, it may be easier to form relief-cut features than protrusions that extend beyond the plane extending through the top surface 172. Also, forming the features of the cutting element 152 as relief-cut features may facilitate forming the removed material into tight ribbons and/or smaller chips. In an embodiment, the cutting element 152 may include a feature (e.g., the lip 196 of the chip breaker 190) that extends further from the bottom surface 173 than the top surface 172. The feature extending further from the bottom surface 173 than the top surface 172 may, in some embodiments, facilitate forming the removed material into tight ribbons and/or smaller chips.

It is noted that other configurations of chip breakers may be incorporated into the superhard elements 152, including discrete, discontinuous breakers formed adjacent individual cutting faces or edges 160A-160D. Other non-limiting examples of features and configurations that may assist with chip breaking include those described in U.S. Pat. No. 9,278,395, the disclosure of which is incorporated by reference herein in its entirety.

Various methods may be employed to form the opening 180, countersunk region 182, chip breaker 190, or other geometric features, including processes such as laser machining and laser cutting. Some non-limiting methods of forming such features in the cutting element are described in U.S. Pat. No. 9,089,900 (entitled METHOD OF PRODUCING HOLES AND COUNTERSINKS IN POLYCRYSTALLINE DIAMOND, filed on Dec. 22, 2011), U.S. Pat. No. 9,062,505 (entitles METHOD FOR LASER CUTTING POLYCRYSTALLINE DIAMOND STRUCTURES, filed on Jun. 22, 2011), PCT Patent Application No. PCT/US2018/013069 (entitled ENERGY MACHINED POLYCRSTALLINE DIAMOND COMPACTS AND RELATED METHODS, filed on Jan. 10, 2018, attorney docket number 260249WO01_480566-426), the disclosure of each of which documents is incorporated by reference herein in its entirety. Other methods that may be employed to form the opening 180, the countersunk region 182, the chip breaker 190, or other geometric features includes electrical discharge machining (e.g., wire electrical discharge machining, sinker electrical discharge machining, etc.), grinding, lapping, or any other method.

In an embodiment, at least a portion of a surface of the table 170 may be polished. For example, at least a portion of a surface of the superhard table 170 may be polished to exhibit a surface finish, in root mean square) of about 20 μm or less, about 17.5 μm or less, about 15 μm or less, about 12.5 μm to less, about 10 μm or less, about 7.5 μm or less, about 5 μm or less, about 4 μm or less, about 3 μm or less, about 2 μm or less, about 1.5 μm or less, about 1 μm or less, about 0.75 μm or less, about 0.5 μm or less, about 0.25 μm or less, about 0.1 μm or less, about 0.07 μm or less, or in ranges of about 0.05 μm to about 0.1 μm, about 0.7 μm to about 0.25 μm, about 0.1 μm to about 0.5 μm, about 0.25 μm to about 0.75 μm, about 0.5 μm to about 1 μm, about 0.75 μm to about 1.5 μm, about 1 μm to about 2 μm, about 1.5 μm to about 3 μm, about 2 μm to about 4 μm, about 3 μm to about 5 μm, about 4 μm to about 7.5 μm, about 5 μm to about 10 μm, about 7.5 μm to about 12.5 μm, about 10 μm to about 15 μm, about 12.5 μm to about 17.5 μm, or about 15 μm to about 20 μm. In a particular example, when the superhard table 170 includes PCD, it has been found that polishing the top surface 172 of the PCD table 170 to exhibit any of the above surface finishes may improve the ability of the superhard element 152 to remove material from a workpiece and/or may increase the lifespan of the cutting element 152. However, it is noted that the top surface 172 of carbide superhard elements may not include a polished top surface 172. Examples of surface finishing processes and tables with various surface finishes are described in U.S. patent application Ser. No. 15/232,780 (entitled ATTACK INSERTS WITH DIFFERING SURFACE FINISHES, ASSEMBLIES, SYSTEMS INCLUDING SAME, AND RELATED METHODS, filed Aug. 9, 2016, attorney docket number 4002-0023) and U.S. patent application Ser. No. 16/084,469 (entitled ENERGY MACHINED POLYCRYSTALLINE DIAMOND COMPACTS AND RELATED METHODS filed on Sep. 12, 2018), the disclosure of each of which is incorporated by reference herein, in its entirety, by this reference.

While the superhard elements 152 and the cutting tool 104 may be used in a variety of machining processes, and for machining of a variety of materials, it has been determined that use of superhard elements 152 having a PCD table 170 combined with a tool body 150 formed of a material comprising aluminum unexpectedly provides various benefits when machining a workpiece formed of titanium. While the exact mechanisms for improved efficiency and effectiveness of the machining of titanium are not entirely understood, it is believed that the use of an aluminum tool body may provide compliance, that such a configuration may provide enhanced thermal conductivity of the cutting tool 104, or some combination of the two characteristics may result in an enhanced performance of the machining process.

In some embodiments, the cutting elements may be beneficial in machining other thermal resistance materials. For example, in some embodiments, the superhard elements 152 of the present disclosure may provide advantages in machining materials having a thermal conductivity of less than approximately 50 watts per meter-Kelvin (W/m·K). In some embodiments, the superhard elements 152 of the present disclosure may be beneficial in machining materials having a thermal conductivity of less than approximately 30 W/m·K. In some embodiments, the superhard elements 152 of the present disclosure may be beneficial in machining materials having a thermal conductivity of less than approximately 20 W/m·K.

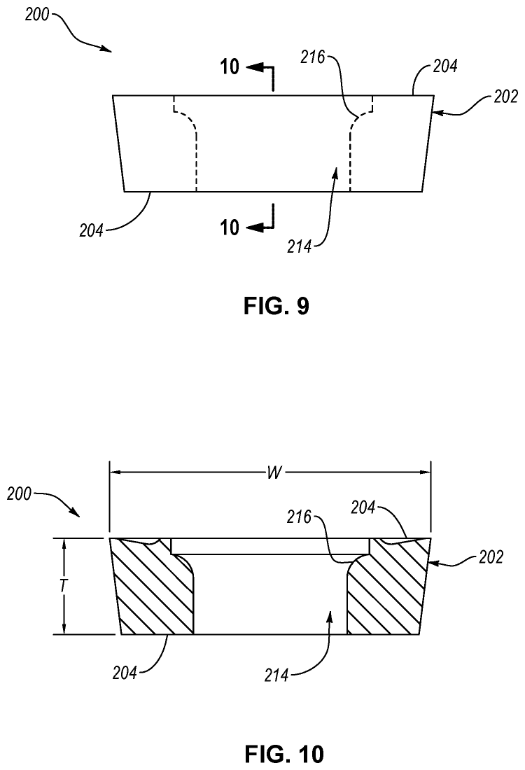

Referring now to FIGS. 9-11, a cutting element 200 according to another embodiment of the present disclosure is provided. Except as otherwise disclosed herein, the cutting element 200 is the same as or substantially similar to any of the cutting elements disclosed herein. The cutting element 200 may comprise superhard, superabrasive materials. For example, the cutting element 200 may include polycrystalline cubic boron nitride, polycrystalline diamond and/or other superabrasive materials. As with previously described embodiments, the cutting element 200 may include a superhard, superabrasive table 202 defining a top surface 204 (i.e., a rake surface). In some embodiments, the cutting element 200 may comprise a PCD table 202 with no substrate or other structure attached thereto. In some embodiments, as previously noted, the cutting element 200 may comprise, it may consist of, or it may consist essentially of a superhard, superabrasive table 202, such as a PCD table. In an embodiment, the table 202 may be initially formed with a substrate during an HPHT process (with the substrate providing a catalytic material such as previously described), and the substrate may be removed after the HPHT process. In other embodiments, the table 202 may be formed by mixing a catalytic material with diamond powder or otherwise providing a catalytic material prior to an HPHT process.

In one particular example, the table 202 may include a relatively “thick diamond” table which exhibits a thickness (i.e., from the top surface 204 to a bottom 206 opposite the top surface 204) that is approximately 3.75 mm or greater. In other embodiments, the table 202 exhibits a thickness of approximately 5 mm or greater or 7.6 mm or greater. In yet other embodiments, the table 202 may exhibit a lesser thickness (e.g., 2.5 mm or less or 1.25 mm or less).

In one embodiment, the table 202 exhibits a thickness between approximately 1.25 mm and approximately 2.5 mm. In one embodiment, the table 202 exhibits a thickness between approximately 2.5 mm and approximately 3.75 mm. In one embodiment, the table 202 exhibits a thickness between approximately 3.75 mm and approximately 10 mm. In one embodiment, the table 202 exhibits a thickness between approximately 3.75 mm and approximately 5 mm. In one embodiment, the table 202 exhibits a thickness between approximately 5 mm and approximately 7.6 mm. In one embodiment, the table 202 exhibits a thickness between approximately 7.6 mm and approximately 10 mm. In one embodiment, the table 202 exhibits a thickness between approximately 10 mm and approximately 12.7 mm. In one embodiment, the table 202 exhibits a thickness between approximately 12.7 mm and approximately 15.25 mm. In one embodiment, the table 202 exhibits a thickness between approximately 15.25 mm and approximately 17.75 mm. In one embodiment, the table 202 exhibits a thickness between approximately 17.75 mm and approximately 20.3 mm. In one embodiment, the table 202 exhibits a thickness between approximately 20.3 mm and approximately 22.8 mm. In one embodiment, the table 202 exhibits a thickness between approximately 22.8 mm and approximately 25.4 mm. In one embodiment, the table 202 exhibits a thickness between approximately 3.75 mm and approximately 7.6 mm.

As depicted in FIGS. 9-11, the cutting elements 200 may be configured to exhibit a substantially square outer profile, a rounded square outer profile, and/or a substantially rounded square outer profile when viewed from above (e.g, as seen specifically in FIG. 5). Such a geometry provides multiple cutting edges which may be indexed relative to a cutting tool body 150 for extended service of the cutting elements 200. In one embodiment, the cutting element 200 may have a face that exhibits a substantially square profile that exhibits a width W of approximately 12.7 mm to 17.8 mm. In another embodiment, the width W may be approximately 10.1 mm to 20.3 mm. In another embodiment, the width W may be approximately 7.6 mm to 22.9 mm. In another embodiment, the width W may be approximately 5 mm to 19.1 mm inch. In another embodiment, the width W may be approximately 19 mm to 25.4 mm. In another embodiment, the width W may be approximately 9.4 mm. In another embodiment, the width W may be approximately 11.9 mm. In some embodiments, the square profile may include rounded or chamfered corners or transitions between sides.

As previously noted, other shapes and outer profiles are contemplated including, for example, generally circular, generally curved, generally triangular, generally rhombus, generally hexagonal, generally octagonal, and other generally regular or generally irregular polygons.

As seen in FIGS. 9 and 10, the cutting elements 200 may also include an opening 214 formed in the table 202 to accommodate a fastener and/or a clamping element for coupling of the cutting element 200 with a cutting tool body 150. The opening 214 may include a countersunk region 216 (or a counter bore, depending on the type of fastener being used) to enable a fastener and/or clamping element to be positioned flush with or below the top surface 204 of the table 202 when the cutting element 200 is coupled with a cutting tool body 150.

It is noted that other features may be provided in the cutting elements 200 including, for example, features for breaking chips of material that are being removed from the workpiece when engaged by the rotating cutting tool 104. For example, the cutting elements may include formations or structures referred to as chip breakers as has been previously described.

The table 202 may be formed in accordance with methods and techniques previously described herein and may include features and characteristics similar or identical to those described herein with respect to other embodiments.

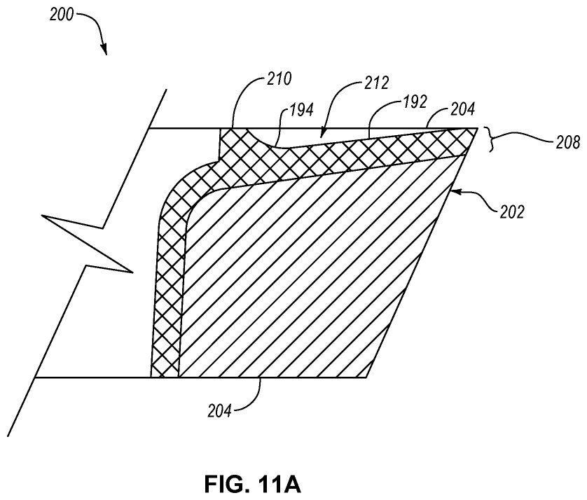

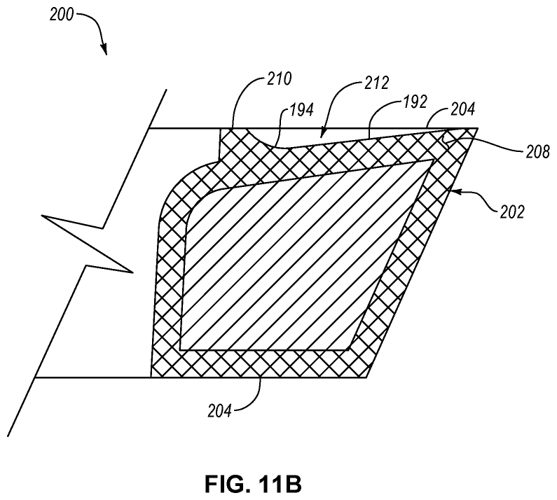

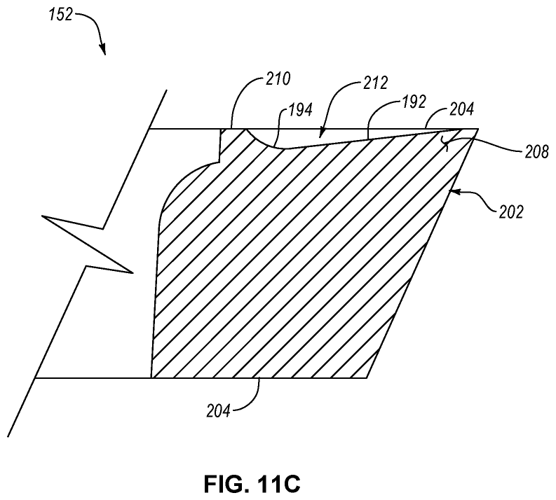

For example, the PCD table 202 may include a plurality of directly bonded-together diamond grains exhibiting diamond-to-diamond bonding therebetween (e.g., sp3 bonding), which define a plurality of interstitial regions. A portion of, or substantially all of, the interstitial regions of the PCD table may include a metal-solvent catalyst or a metallic infiltrant disposed therein that is infiltrated from a substrate or from another source during fabrication. For example, the metal- solvent catalyst or metallic infiltrant may be selected from iron, nickel, cobalt, and alloys of the foregoing. In some embodiments, the PCD table 202 may further include thermally-stable diamond in which the metal-solvent catalyst or metallic infiltrant has been partially or substantially completely depleted (e.g., region 208 shown in FIGS. 11A-11C) from a selected surface or volume of the PCD table, such as via an acid leaching process. Thermally-stable PCD may also be sintered with one or more alkali metal catalysts. In some embodiments, a catalyst-depleted region 208 may exhibit a depth that is substantially conformal with an outer surface of the PCD table 202, such as shown in FIGS. 11A and 11B. In other embodiments, the catalyst-depleted region 208 may generally extend a desired depth from a plane extending through the uppermost portions of the table 202 (e.g., through the peripheral edges of the top surface 204 and/or through the upper surface of the lip 210). Thus, removal of the catalyst or infiltrant may be done prior to or after the forming of the structures and features (e.g., chip breakers 212, opening 214, etc.). As previously noted, in some embodiments, catalyst material may be removed from substantially the entire PCD table 202, such as shown in FIG. 11C.

As discussed above, in some embodiments, the table 202 may be leached to deplete a metal-solvent catalyst or a metallic infiltrant therefrom in order to enhance the thermal stability of the table 202. For example, when the table 202 is a PCD table, the table 202 may be leached to remove at least a portion of the metal-solvent catalyst that was used to initially sinter the diamond grains to form a leached thermally-stable region 208, from a working region thereof to a selected depth. The leached thermally-stable region 208 may extend inwardly from the top surface 204 to a selected depth. In an embodiment, the depth of the thermally-stable region may be about 30 μm to about 1,500 μm. More specifically, in some embodiments, the selected depth is about 50 μm to about 900 μm, about 200 μm to about 600 μm, or about 600 μm to about 1200 μm. The leaching may be performed in a suitable acid, such as aqua regia, nitric acid, hydrofluoric acid, or mixtures of the foregoing.

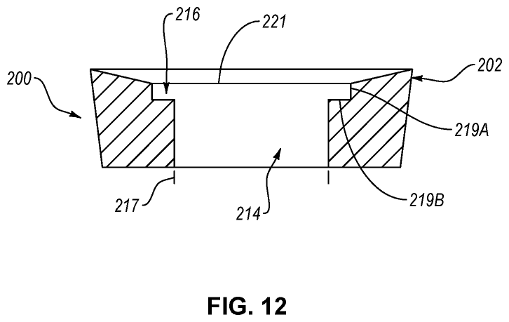

Referring briefly to FIG. 12, a cutting element 200 is shown with a different cross- sectional profile. The cutting element 200 may include features and aspects such as described hereinabove with respect to other embodiments. For example, the cutting element 200 may include an opening 214 formed in a table 202 to accommodate a fastener and/or a clamping element for coupling of the cutting element 200 with a cutting tool body 150. The opening 214 may include a countersunk region 216 (or a counter bore, depending on the type of fastener 217 being used) to enable a fastener and/or clamping element to be positioned flush with or below the top surface 204 of the table 202 when the cutting element 200 is coupled with a cutting tool body 150. In the embodiment shown in FIG. 12, the countersunk region 216 includes a counterbore which may be formed, in the profile shown, to provide a wall 219A and a floor 219B formed substantially at right angles relative to each other, and configured to accept the head 221 of a fastener 217. The fastener 217, including the head 221 of the fastener, may be configured to, at least in part, be substantially congruent with, conformal with, or otherwise correspond in size and shape with the counterbore or countersunk region. For example, as shown, the cross-sectional profile of the head 221 of the fastener 217 correlates or is congruent with the cross-sectional profile of the counterbore region. In other embodiments, for example, both the head of a fastener and the countersunk region may be tapered, stepped, or a combination of geometric shapes or features in a corresponding and at least partially conformal manner.

It is noted that other features may be provided in the cutting element 200 shown in FIG. 12, including, for example, features for breaking chips of material that are being removed from the workpiece when engaged by the rotating cutting tool 104. For example, the cutting element 200 may include formations or structures referred to as chip breakers (e.g., declining ramped surface portion 192, return portion 194, and lip 210) as has been previously described.

The table 202 may be formed in accordance with methods and techniques previously described herein and may include features and characteristics similar or identical to those described herein with respect to other embodiments.

For example, the PCD table 202 may include a plurality of directly bonded-together diamond grains exhibiting diamond-to-diamond bonding therebetween (e.g., sp3 bonding), which define a plurality of interstitial regions. A portion of, or substantially all of, the interstitial regions of the PCD table 202 may include a metal-solvent catalyst or a metallic infiltrant disposed therein that is infiltrated from a substrate or from another source during fabrication. For example, the metal-solvent catalyst or metallic infiltrant may be selected from iron, nickel, cobalt, and alloys of the foregoing. In some embodiments, the PCD table 202 may further include thermally-stable diamond in which the metal-solvent catalyst or metallic infiltrant has been partially or substantially completely depleted from a selected surface or volume of the PCD table, such as via an acid leaching process. Locations, sizes, depths, and configurations of catalyst depleted areas may be formed similar to those described above with respect to other embodiments including, for example, removal of catalyst material from substantially the entire table 202.

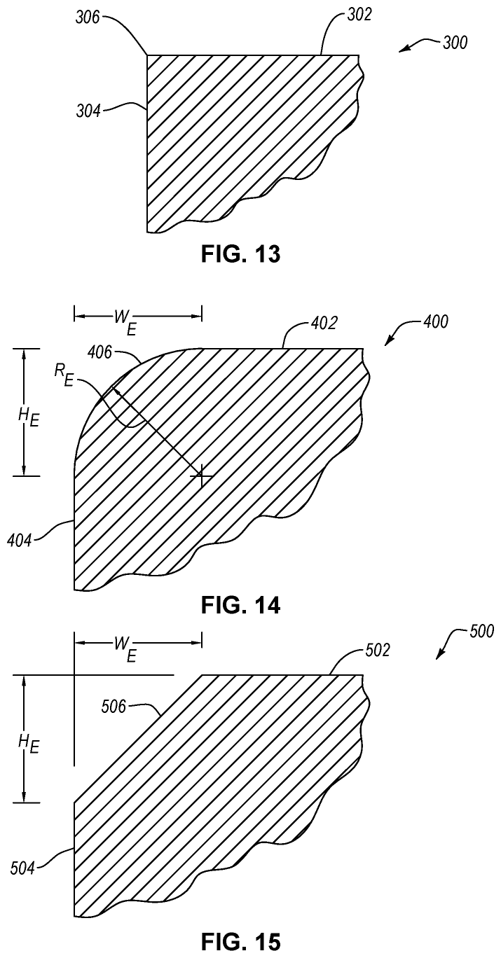

FIGS. 13-15 are enlarged, cross-sectional views of a portion of superhard elements having different edges, according to different embodiments. Except as otherwise disclosed herein, the cutting elements illustrated in FIGS. 13-15 may be the same as or substantially similar to any of the superhard elements disclosed herein.

Referring to FIG. 13, the superhard element 300 includes a top surface 302 and at least one outer lateral surface 304. The superhard element 300 also includes an edge 306 extending (i.e., at the intersection) between the top surface 302 and the lateral surface 304. The edge 306 is a sharp corner. As used herein, an edge that is sharp corner includes any edge exhibiting an average radius of curvature that is less than 2 μm. Conventional knowledge indicates that the sharp corner of the edge 306 facilitates the removal of material from the workpiece. However, it has been unexpectedly found that the sharp corner of the edge 306 decreases the lifespan of the superhard element 300, especially as the hardness of the superhard element 300 is increased. For example, it has been found that the sharp corner of the edge 306 may include imperfections that initiate wear of the edge 306 and is more likely to chip or otherwise fracture during use compared to other edges. Thus, in some embodiments, the cutting elements disclosed herein may include a cutting edge that is not a sharp corner.

For example, referring to FIG. 14, the superhard element 400 includes a top surface 402 and at least one lateral surface 404. The superhard element 400 also includes an edge 406 extending between the top surface 402 and the lateral surface 404. The edge 406 is rounded. For example, the edge 406 exhibits a generally quarter-circular shape, a generally quarter-elliptical shape, a generally quarter-oval shape, a generally parabolic shape, or any other suitable curved shape. In some embodiments, the edge 406 may exhibit an average radius of curvature that is greater than about 2.5 μm. The rounded edge 406 may strengthen the edge 406 compared to the sharp corner of the edge 306 of FIG. 13. The rounded edge 406 may also remove or at least reduce the quantity and size of imperfections on the edge 406 that initiate wear compared to the edge 306, such as imperfections formed during the HPHT process that formed the superhard element 400.

The rounded edge 406 exhibits a width W_{E} measured from the lateral surface 404 to the top surface 402 in a direction that is generally parallel to the top surface 402. The width W_{E} may be the minimum width measured from the lateral surface 404 to the top surface 402. The width W_{E} may be about 2.5 μm to about 10 μm, about 5 μm to about 15 μm, about 10 μm to about 20 μm, about 17 μm to about 22 μm, about 20 μm to about 24 μm, about 22 μm to about 26 μm, about 24 μm to about 28 μm, about 26 μm to about 30 μm, about 28 μm to about 32 μm, about 30 μm to about 34 μm, about 32 μm to about 36 μm, about 34 μm to about 38 μm, about 36 μm to about 40 μm, about 20 μm to 80 μm, about 38 μm to about 42 μm, about 40 μm to about 45 μm, about 42 μm to about 47 μm, about 45 μm to about 50 μm, about 47 μm to about 52 μm, about 50 μm to about 55 μm, about 52 μm to about 57 μm, about 55 μm to about 60 μm, about 57 μm to about 62 μm, about 60 μm to about 65 μm, about 62 μm to about 67 μm, about 65 μm to about 70 μm, about 67 μm to about 72 μm, about 70 μm to about 75 μm, about 72 μm to about 76 μm, about 75 μm to about 80 μm, about 77 μm to about 85 μm, about 80 μm to about 90 μm, about 85 μm to about 95 μm, or about 90 μm to about 100 μm. Generally, increasing the width W_{E} strengthens the edge 406 thereby may reduce chipping of the edge 406 and may increase the quantity and size of the imperfections that are removed from the edge 406. However, increasing the width W_{E} (e.g., W_{E} is greater than 30 μm) decreases the ability of the superhard element 400 to effectively remove material from the workpiece. Thus, the width W_{E} may be selected based on balancing these issues. It is noted that, generally, any benefits from rounding the edge 406 are generally negated when the width W_{E} is smaller than about 20 μm or larger than 80 μm though, in some embodiments, it may be beneficial to select the width W_{E} to be smaller than about 20 μm or larger than 80 μm.

It is noted that the rounded edge 406 may exhibit a height H_{E} measured from the top surface 402 to the lateral surface 404 in a direction that is generally parallel to the lateral surface 404. The height H_{E} may be the minimum height measured from the top surface 402 to the lateral surface 404 in a direction that is substantially parallel to the lateral surface 404 and/or substantially perpendicular to the top surface 402. The rounded edge 406 may also exhibit an average radius R_{E}. The height H_{E} and the average radius R_{E} of the rounded edge 406 may be independently selected to be 2.5 μm to about 10 μm, about 5 μm to about 15 μm, about 10 μm to about 20 μm, about 17 μm to about 22 μm, about 20 μm to about 24 μm, about 22 μm to about 26 μm, about 24 μm to about 28 μm, about 26 μm to about 30 μm, about 28 μm to about 32 μm, about 20 μm to about 80 μm, about 30 μm to about 34 μm, about 32 μm to about 36 μm, about 34 μm to about 38 μm, about 36 μm to about 40 μm, about 38 μm to about 42 μm, about 40 μm to about 45 μm, about 42 μm to about 47 μm, about 45 μm to about 50 μm, about 47 μm to about 52 μm, about 50 μm to about 55 μm, about 52 μm to about 57 μm, about 55 μm to about 60 μm, about 57 μm to about 62 μm, about 60 μm to about 65 μm, about 62 μm to about 67 μm, about 65 μm to about 70 μm, about 67 μm to about 72 μm, about 70 μm to about 75 μm, about 72 μm to about 76 μm, about 75 μm to about 80 μm, about 77 μm to about 85 μm, about 80 μm to about 90 μm, about 85 μm to about 95 μm, or about 90 μm to about 100 μm. The height H_{E} and the average radius R_{E} of the rounded edge 406 may be selected for the same reasons as the width W_{E}. In an embodiment, when the rounded edge 406 is a generally rounded quarter-circle, the width W_{E}, the height H_{E}, and the average radius R_{E} are substantially the same.

The rounded edge 406 may be formed using any suitable technique. For example, the rounded edge 406 may be formed using a brush (e.g., a diamond-impregnated nylon brush or other brush including superhard materials embedded in the fibers), using a laser, grinding, electro-discharge machining, during the HPHT process, or another suitable process. In a particular example, the rounded edge 406 is formed by rotating a brush relative to at least a portion of the top surface 402 and the lateral surface 404 to remove a portion of the superhard element 400 to form the curved rounded edge 406. It has been found that using the brush to form the rounded edge 406 forms a relatively consistent edge substantially without imperfections caused by removing material. In a particular example, the rounded edge 406 is formed using a laser. Using the laser to form the rounded edge 406 may facilitate formation of the rounded edge 406 since the laser may be used to form the other features (e.g., the opening) of the superhard element 400 and/or polish one or more surfaces of the superhard element 400. As such, using the laser to form the rounded edge 406 allows the rounded edge 406 to be formed in the same process that forms the other features of the superhard element 400. However, it is noted that forming the rounded edge 406 with a laser may form micro- or nano-sized divots corresponding to the individual laser pulses used to form the rounded edge 406. It is currently believed by the inventors that the divots formed by the laser are less likely to initiate wear compared to imperfections formed during the HPHT process, but may initiate wear on the rounded edge 406 faster than if the rounded edge 406 was formed using a brush.

Referring to FIG. 15, the superhard element 500 includes a top surface 502 and at least one outer lateral surface 304. The superhard element 500 also includes an edge 506 extending between the top surface 502 and the lateral surface 504. The edge 506 is a chamfer (e.g., substantially flat and non-rounded surface). The chamfered edge 506 may strengthen the edge 506 compared to the sharp corner of the edge 306 of FIG. 13. The chamfered edge 506 may also remove or at least reduce the quantity and size of imperfections on the edge 506 that initiate wear compared to the edge 306, such as imperfections formed during the HPHT process that formed the superhard element 500. It is noted that the chamfered edge 506 may be more difficult to form compared to the rounded edge 406 of FIG. 14, since the chamfered edge may not be easily formed using a brush.

The chamfered edge 506 may exhibit a width W_{E} and a height H_{E} that is the same as the width W_{E} and the height H_{E} of the rounded edge 406 of FIG. 14. The chamfered edge 506 may be formed using any of the same techniques as the rounded edge 406 of FIG. 14.

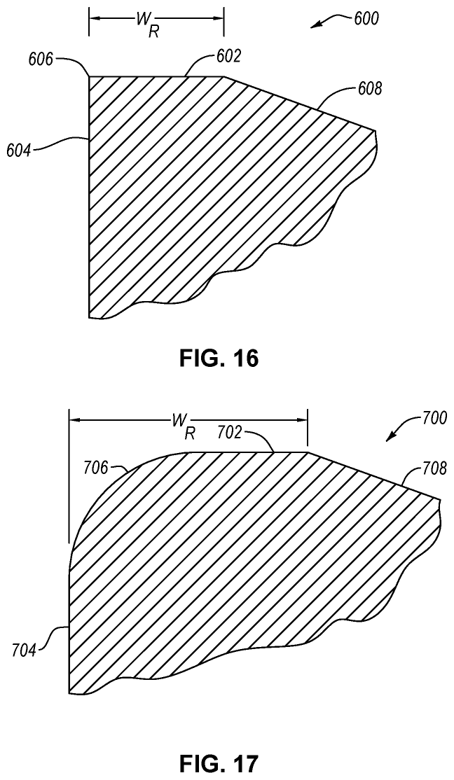

FIGS. 16 and 17 are enlarged cross-sectional views of different cutting elements, according to different embodiments. Except as otherwise disclosed herein, the cutting elements of FIGS. 16 and 17 may be the same or substantially similar to any of the cutting elements disclosed herein.

Referring to FIG. 16, the superhard element 600 includes a top surface 602 and a lateral surface 604. The top surface 602 is a rake surface of the superhard element 600. The superhard element 600 also includes a cutting edge 606. The cutting edge 606 is illustrated as being a relatively sharp cutting edge though, as discussed in more detail with regards to FIG. 17, the cutting edge 606 may include any other cutting edge disclosed herein. The superhard element 600 further includes a declining ramped surface portion 608 extending inwardly from the top surface 602.

The superhard element 600 is configured to remove material from a workpiece. It is desirable to prevent the removed material from contacting the workpiece during operation and to minimize contact between the removed material and the superhard element 600. For example, contacting the workpiece with the removed material may damage the workpiece which, in turn, may damage the cutting element. Also, maintaining contact between the superhard element 600 and the removed material may increase wear on the superhard element 600 and increase the likelihood that the removed material contacts the workpiece. As such, the superhard element 600 may be configured to at least one of break the removed material into small pieces, form relatively tight curls to prevent the removed material from contacting the workpiece, or break the curls (e.g., tight curls) before the curls become large enough to contact the workpiece. It has been found that the rake width W_{R} of the superhard element 600 and the depth of cut of the workpiece relative to the rake width W_{R} may surprisingly affect the ability of the superhard element 600 to at least one of break the removed material into small pieces, form relatively tight curls, and/or break the curls before the curls become large enough to contact the workpiece.

The rake width W_{R} of the top surface 602 is measured from the lateral surface 604, such as from the lateral surface 604 to the declining ramped surface portion 608. The rake width W_{R} is also measured in a direction that is parallel to the top surface 602. In the illustrated embodiment, the rake width W_{R} is generally equal to the width of the top surface 602 since the edge 606 is relatively sharp and the width of the edge 606 is negligible. The rake width W_{R} may be selected to be about 30 μm to about 500 μm, such as about 50 μm to about 500 μm, about 30 μm to about 50 μm, about 40 μm to about 60 μm, about 50 μm to about 70 μm, about 60 μm to about 80 μm, about 70 μm to about 90 μm, about 80 μm to about 100 μm, about 90 μm to about 120 μm, about 100 μm to about 140 μm, about 120 μm to about 160 μm, about 140 μm to about 180 μm, about 160 μm to about 200 μm, about 180 μm to about 225 μm, about 200 μm to about 250 μm, about 225 μm to about 275 μm, about 250 μm to about 300 μm, about 275 μm to about 325 μm, about 300 μm to about 350 μm, about 325 μm to about 375 μm, about 350 μm to about 400 μm, about 375 μm to about 450 μm, or about 400 μm to about 500 μm. It is currently believed that material removed from the workpiece initially moves along the top surface 602. It has been found that moving the material along the top surface 602 when the superhard element 600 exhibits any of the above rake widths W_{R} causes the removed material to break into small pieces or to form relatively tight curls that are unlikely to contact the workpiece before breaking off.

The rake width W_{R} that may at least partially cause the superhard element 600 to effectively break the removed material into small pieces and/or form tight curls depends on a number of factors. In an example, as will be discussed in more detail below, the rake width W_{R} that effectively breaks the removed material into small pieces or tight curls may depend on the depth of cut. In an example, the rake width W_{R} that effectively breaks the removed material into small pieces or tight curls may depend on the composition of the material that is being removed. In an example, the rake width W_{R} that may effectively break the removed material into small pieces or tight curls may depend on whether the top surface 602 is oriented in a positive rake angle (e.g., a rake angle of 1° to 10° or 1° to 5°), a negative rake angle (e.g., a rake angle of −1° to −10° or −1° to −5°), or a neutral rake angle (e.g., a rake angle of −1° to 1°).

The rake width W_{R} of the superhard element 600 may be selected based on a number of reasons unrelated to the ability of the superhard element 600 to break the removed material into small pieces and/or tight curls. In an example, the rake width W_{R} may be selected to be greater than 35 μm because it may be difficult or impossible to polish the top surface 602 and/or form a rounded or chamfered edge (as discussed in more detail with regards to FIG. 17) when the rake width W_{R} of the superhard element 600 is smaller than about 35 μm. In an example, it has been found that increasing the rake width W_{R} of the superhard element 600 to be greater than 85 μm may increase the likelihood that the superhard element 600 chips or otherwise fails during use. It is noted that decreasing the rake width W_{R} may decrease the likelihood that the superhard element 600 chips or otherwise fails during use.

It has been found that the ability of the superhard element 600 to break the removed material into small pieces and/or tight curls may at least partially depend on the depth of cut (e.g., the thickness of material removed from the workpiece with each pass of the superhard element 600) relative to the rake width W_{R}. For example, when the rake width W_{R} is greater than the depth of cut, it has been found that the superhard element 600 is likely to form large curls of material that contact the workpiece, thereby damaging the workpiece and the superhard element 600. Also, selecting the rake width W_{R} to be greater than the depth of cut may increase the surface area of the top surface 602 that is in contact with the removed material, thereby increasing the likelihood that the top surface 602 chips or otherwise fails. As such, in some embodiments, the rake width W_{R} of the superhard element 600 is selected to be equal to or less than the depth of cut. In such embodiments, the rake width W_{R} may be selected to be 100% (i.e., equal to) to 10% the depth of cut (i.e., rake width W_{R}=0.1*depth of cut), such as about 10% to about 20%, about 15% to about 25%, about 20% to about 30%, about 25% to about 35%, about 30% to about 40%, about 35% to about 45%, about 40% to about 50%, about 45% to about 55%, about 50% to about 60%, about 55% to about 65%, about 60% to about 70%, about 65% to about 75%, about 70% to about 80%, about 75% to about 85%, about 80% to about 90%, about 85% to about 95%, or about 90% to 100%. Generally, decreasing the rake width W_{R} relative to the depth of cut increases the likelihood that the superhard element 600 breaks the material removed from the workpiece into small pieces and/or forms the material removed from the workpiece into tight curls. However, it has been found that decreasing the rake width W_{R} to be 60% or less and, more particularly, 50% or less the depth of cut may surprisingly increase the likelihood that the removed material is broken into small pieces or formed into tight curls.

The depth of cut may be selected to be about 400 μm or less, such as about 300 μm or less, about 250 μm or less, about 200 μm or less, about 175 μm or less, about 150 μm or less, about 125 μm or less, about 100 μm or less, or in ranges of about 100 μm to about 150 μm, about 125 μm to about 175 μm, about 150 μm to about 200 μm, about 175 μm to about 225 μm, about 200 μm to about 250 μm, about 200 μm to about 300 μm, or about 250 μm to about 400 μm. In an example, the depth of cut may be selected based on the rake width W_{R} of the superhard element 600. In an example, the depth of cut may be selected based on the material of the workpiece. For example, it has been found that increasing the depth of cut beyond 250 μm (e.g., when the workpiece includes titanium) may surprisingly increase the likelihood that the superhard element 600 chips or otherwise fails.

Referring to FIG. 17, the superhard element 700 includes a top surface 702 and a lateral surface 704. The top surface 702 is a rake surface of the superhard element 700. The superhard element 700 also includes an edge 706. The edge 706 is illustrated as being a rounded edge similar to the edge 406 of FIG. 14. However, it is noted that the edge 706 may be a chamfered edge similar to the edge 506 of FIG. 15. The superhard element 700 further includes a declining ramped surface portion 708 extending inwardly from the top surface 702.

The superhard element 700 exhibits a rake width W_{R} measured from the lateral surface 704 in a direction that is parallel to the top surface 702. The rake width W_{R} of the superhard element 700 may be the same as the rake width W_{R} of the superhard element 600 of FIG. 16 except that the rake width W_{R} of the superhard element 700 includes the width of the edge 706 since the width of the edge 706 is not negligible. In other words, the rake width W_{R} includes the width of the top surface 702 and the width of the edge 706. However, the rake width W_{R} of the superhard element 700 may exhibit any of the same widths and relationships with the depth of cut as the rake width W_{R} of the superhard element 600 of FIG. 16.

The superhard elements illustrated in FIGS. 1-17 are examples of cutting elements. However, it is noted that the superhard elements may include elements other that cutting elements. For example, the superhard elements that may include superhard nozzles, subterranean drilling elements, or other elements that include superhard materials. The non-cutting element superhard elements may include any of the features disclosed herein. For example, the non-cutting element superhard elements may include an edge that may be the same as or substantially similar to any portion of of the edges 406 or 506 of FIGS. 14 and 15, especially when any portion of such edge is configured to contact abrasive materials.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall have the same meaning as the word “comprising” and variants thereof (e.g., “comprise” and “comprises”).

1. A superhard element, comprising:
a top surface;
a bottom surface opposite the top surface;
at least one lateral surface extending at least partially between the top surface and the bottom surface; and
a surface distinct from the top surface that is angled or curved relative to the top surface.

2. The superhard element of claim 1 wherein the surface distinct from the top surface that is angled or curved relative to the top surface forms a cutting edge.

3. The superhard element of claim 2 further comprising an edge extending between the top surface and the at least one lateral surface, the edge forming the surface distinct from the top surface that is angled or curved relative to the top surface.

4. The superhard element of claim 3 wherein the edge exhibits an edge width measured from the at least one lateral surface and perpendicular to the top surface, and wherein the edge width is about 20 μm to about 80 μm.

5. The superhard element of claim 3, wherein the edge exhibits an edge width measured from the at least one lateral surface and perpendicular to the top surface, and the edge width is about 20 μm to about 40 μm.

6. The superhard element of claim 1 wherein no feature of the superhard element extends further from the bottom surface than the top surface.

7. The superhard element of claim 1 wherein the superhard element exhibits a rake width measured from the at least one lateral surface and perpendicular to the top surface, wherein the rake width is about 50 μm to about 400 μm.

8. The superhard element of claim 1 further comprising an edge extending between the top surface and the at least one lateral surface, wherein the edge is a sharp corner.

9. The superhard element of claim 1 wherein the top surface exhibits a surface finish, in root mean square, of about 10 μm or less.

10. The superhard element of claim 1 wherein the top surface and at least a portion of the at least one lateral surface includes polycrystalline diamond.

11. The superhard element of claim 1 wherein the superhard element includes substantially only polycrystalline diamond.

12. The superhard element of claim 1 wherein the superhard element is a cutting element defining an opening spaced from the at least one lateral surface, the opening configured to receive a fastener.

13. A cutting tool, comprising:
a cutting tool body; and
at least one cutting element attached to the cutting tool body, the at least one cutting element including the superhard element of claim 1.

14. A method of forming a superhard element, the method comprising:
providing a superhard element, the superhard element including a top surface, a bottom surface opposite the top surface, and at least one lateral surface extending at least partially between the top surface and the bottom surface; and
forming a surface distinct from the top surface that is angled or curved relative to the top surface.

15. The method of claim 14 wherein forming a surface distinct from the top surface that is angled or curved relative to the top surface includes forming a rounded edge or chamfered edge extending between the top surface and the at least one lateral surface, the rounded edge or chamfered edge exhibiting the edge width measured from the at least one lateral surface and perpendicular to the top surface, and wherein the edge width is about 20 μm to about 80 μm.

16. The method of claim 15 wherein forming the edge includes contacting a rotating brush against at least a portion of the top surface and at least a portion of the at least one lateral surface.

17. The method of claim 16 wherein the rotating brush include a diamond-impregnated nylon brush.

18. The method of claim 15 wherein forming the rounded edge or chamfered edge includes lasing the superhard element to form the edge.

19. The method of claim 15 wherein forming the rounded edge or chamfered edge includes at least one of grinding or using electric discharge machining to remove at least a portion of the superhard element.

20. The method of claim 14, further comprising forming no feature that extends further from the bottom surface than the top surface.

21. A method of removing material from a workpiece, the method comprising:
providing a cutting tool, the cutting tool comprising:
a cutting tool body;
at least one cutting element attached to the cutting tool body, the at least one cutting element including:
a top surface;
a bottom surface opposite the top surface;
at least one lateral surface extending between the top surface and the bottom surface; and
a surface distinct from the top surface that is angled or curved relative to the top surface;
rotating at least one of the cutting tool or the workpiece about an axis; and
engaging the workpiece with the cutting tool.

22. The method of claim 21, wherein the superhard element exhibits a rake width measured from the at least one lateral surface and measured parallel to the top surface, and wherein the rake width is about 50 μm to about 500 μm and no feature of the superhard element extends further from the bottom surface than the top surface.

23. The method of claim 22 wherein engaging the workpiece with the cutting tool includes engaging the workpiece with the cutting tool with a depth of cut that is equal to or less than the rake width.

24. The method of claim 23, wherein the rake width is about 60% or less the depth of cut.

25. The method of claim 23, wherein the rake width is about 50% or less the depth of cut.

26. The method of claim 23, wherein the depth of cut is about 200 μm or less.

27. A superhard element, comprising:
a top surface;
a bottom surface opposite the top surface;
at least one lateral surface extending at least partially between the top surface and the bottom surface; and
an edge extending between the top surface and the at least one lateral surface.
wherein no feature of the superhard element extends further from the bottom surface than the top surface.

28. The superhard element of claim 27 wherein the edge exhibits an edge width measured from the at least one lateral surface and perpendicular to the top surface, and wherein the edge width is about 20 μm to about 80 μm.

29. The superhard element of claim 27 wherein the superhard element exhibits a rake width measured from the at least one lateral surface and perpendicular to the top surface, wherein the rake width is about 50 μm to about 400 μm.

30. The superhard element of claim 27 wherein the edge is a sharp corner.

31. The superhard element of claim 27 wherein the edge is curved or angled relative to the top surface.
